(19) United States
(12) Patent Application Publication
(10) Pub. No.: US 2008/0040028 A1
(43) Pub. Date: Feb. 14, 2008

(54) Method and Apparatus for Providing Scroll Buttons

(76) Inventor: Richard Crump, Boston, MA (US)

Correspondence Address: McGUINNESS & MANARAS LLP, 125 NAGOG PARK, ACTON, MA, 01720, US

(21) Appl. No.: 11/838,587

(22) Filed: Aug. 14, 2007

Related U.S. Application Data
(60) Provisional application No. 60/822,253, filed on Aug. 14, 2006.

(51) Int. Cl. G01C 21/32

(52) U.S. Cl. 701/208

(57) ABSTRACT

An interactive map web-based tool is provided which gives the user the ability to customize their use of a map. The present invention includes a customized overlay of point of interest information on an existing map. The information overlay includes icons, drop down lists, information panels, advertising content, pop-up windows and hypertext links which are associated with points of interest, where each point of interest is associated with a class. Drop down lists permit the user to display one or more points of interest by location or class. Visual cues, including color coding, icon shaping and text differentiation for different classes of points of interest allow a user of the map to quickly differentiate area resources. With such an arrangement a traveler can easily select for display only those particular resources that are of interest to the traveler and thereby create a local search experience focused on their specific travel needs.

### RELATED APPLICATIONS

This application claims priority under 35 U.S.C. §1.119(e) to provisional patent application Ser. No. 60/822,253 entitled “Method and Apparatus for Identifying and Displaying Locations of Interest on a Map”, filed Aug. 14, 2006 and incorporated herein by reference.

### FIELD OF THE INVENTION

This invention relates generally to the field of web pages and more particularly to a method and system for providing an customizable, interactive area guide.

### BACKGROUND OF THE INVENTION

There are many internet tools that are provided to assist people who travel to unfamiliar destinations to visit an attraction or attend an event such as a concert, museum show, sale or the like. For example, web sites such as Travelocity include the ability to suggest hotels to a traveler who books air fare on their flight. One problem with the existing technology is that it is often difficult for the traveler to determine the proximity between the hotel and the attraction or event. Often a sequence of additional web-page based tools, such as mapping, directional tools, switchboards, attraction web sites the like are serially and independently invoked by the traveler in an attempt to understand relative distances between attractions, obtain driving directions and contact information for attractions. Such a process is cumbersome and commonly error prone.

### SUMMARY OF THE INVENTION

According to one aspect of the invention an interactive map is provided which gives the user the ability to customize their use of a map. The present invention includes a customized overlay of point of interest information on an existing map. The information overlay includes icons, drop down lists, information panels, advertising content, pop-up windows and hypertext links which are associated with points of interest, where each point of interest is associated with a class. Drop down lists permit the user to display one or more points of interest by location or class. Visual cues, including color coding, icon shaping and text differentiation for different classes of points of interest allow a user of the map to quickly differentiate area resources. With such an arrangement a traveler can easily select for display only those icons related to particular resources that are of interest to the traveler and thereby create a local search experience focused on their specific travel needs.

An information panel provides an alternate view of point of interest information that includes a list of labels of points of interest displayed on the map. It can be appreciated that as more classes of points of interest are displayed on the map, the information panel may become filled with point of interest labels. When the dynamic input window overfills, the browser will cause a scroll bar to be provided at the right edge of the window. Use of a scroll bar is often cumbersome and according to another aspect of the invention paging buttons are also displayed as part of the information panel when the panel overfills to enable the user to quickly page up and down through labels in the information panel without having to use the scroll bar.

### BRIEF DESCRIPTION OF THE FIGURES

FIG. 1 illustrates an exemplary web based communication system in which the present invention may be used;

FIG. 2 illustrates exemplary fields of one embodiment of a point of interest object which may be used by an interactive area guide application of the present invention;

FIG. 3 is a block diagram illustrating elements that may be included as part of an interactive map web page of the present invention;

FIG. 4 is an example of an interactive map web page of the present invention including a You are Here Icon;

FIG. 5 illustrates the pull down You Are Here menu which may be used to change the point of interest location of the Your are Here icon of FIG. 4;

FIGS. 6 and 7 illustrate the selection of a point of interest and the movement of the You are Here icon on the map of FIG. 4;

FIG. 8 is a flow diagram provided to illustrate exemplary steps that may be performed to generate an icon object and display the Icon object on the map;

FIG. 9 illustrates an intelligent pop up window of the present invention which may be displayed by selecting a You are Here element of the interactive map web page of the present invention;

FIG. 10 illustrates a pull down list of classes of point of interests, and the selection of a class from the pull down list;

FIG. 11 illustrates the population of the map with class icons resulting from the selection in FIG. 10;

FIG. 12 illustrates a plurality of class icons of different type, and is provided to illustrate how class icons of different types are assigned different colors, as well as how a hypertext link associated with the class icons is highlighted with the class color when the mouse is proximate to the hypertext link;

FIG. 13 illustrates the different coloring of a hypertext link of a different class than that of FIG. 12;

FIG. 14 illustrates an intelligent pop-up window that is generated upon selection of a particular class icon, including illustrating that the pop-up window has a background color associated with the class;

FIG. 14 is a flow diagram illustrating exemplary steps that may be performed to select and display a class of POIs on a map;

FIG. 15 is a flow diagram illustrating exemplary steps that may be performed to de-select and remove from display a class of POIs on a map;

FIG. 16 is a diagram illustrating a pop-up window that may be displayed on the map for a POI, wherein the pop-up window background color is associated with the Icon color for the class of PO;

FIG. 17 is a block diagram illustrating exemplary fields of the pop-up window;

FIG. 18 is a diagram provided to illustrate population of the dynamic input area of the pop up window of FIG. 17 with a prompt for travel date information for use in invoking a third party reservation system;

FIG. 19 is a diagram provided to illustrate population of the dynamic input area of the pop up window of FIG. 17 a prompt for direction information for use in invoking a third party direction system;

FIG. 20 is flow diagram illustrating exemplary steps that may be performed to populate a pop-up window object for a POI;

FIG. 21 is a diagram illustrating scroll up and scroll down buttons on the information panel of the web page of the present invention; and

FIG. 22 is a flow diagram illustrating a method of incorporating scroll buttons into the browser window.

### DETAILED DESCRIPTION

The present invention leverages the internet's vast resources to enable travelers to use the web smarter, faster and easier for trip planning by integrating a database of destination content with an existing web mapping application to allow users to pick and choose points of interest and classes of points of interest, and to display icons associated with their selections to be superimposed on local city maps, such as hotels, galleries, museums, theaters, shopping malls, etc. With such an arrangement the user can obtain a customized, streamlined visual representation of an area which highlights only the points of interest that are relevant to the particular user's travel needs.

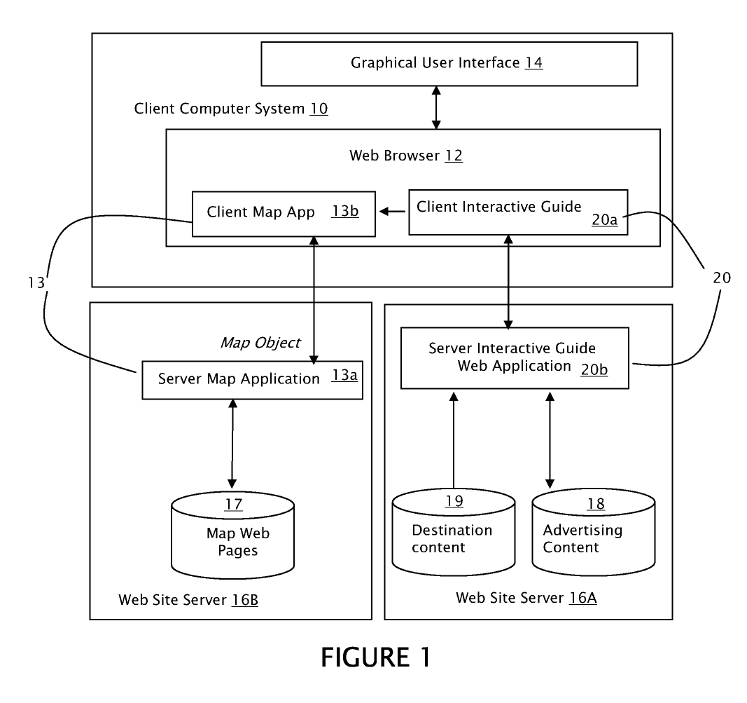

FIG. 1 is a block diagram showing components in an illustrative embodiment of the disclosed system. As shown in FIG. 1, a client computer system 10 includes a web browser 12, which provides a Graphical User Interface (GUI) 14 to a user of the client computer system 10. Web site servers 16A and 16B are coupled to the client computer system via the Internet. Each Web site server serves a web page to the client for display on the GUI.

For example, web site server 16B includes a mapping application 13 (for example Google Maps). The mapping application 13 has access to a number of map images and includes the ability to populate a web page with a map object displaying portions of a map based on various information received by the map application regarding location, type of display (satellite or street map) form factor, etc. The mapping application 13 is shown to include both a client side application 13a and a server side application 13b. The client side application 13a is code which is communicates with and is shown incorporated in web browser 12.

Another web server 16A hosts an interactive area guide web application 20 of the present invention. The interactive area guide application 20 program code which controls the display of point of interest information on a map image provided by the mapping application. The program code may be written in Hyper-Text Markup Language (HTML), eXtensible HTML (XHTML), XML, JAVAscript or the any other type of language that is used to control the appearance and population of web pages. The program code defines particular data structures associated with objects which are displayed on the web page using standard object oriented programming methods. The interactive guide application 20 comprises both a server component 20a and a client component 20b, with the client component 20b communicating with browser 12. The application 20 interfaces with the map application 13 via the browser using Application Programming Interfaces (APIs) associated with the map application. For example, the Google Map application publishes a list of APIs which may be used to provide information to the Google map application and thus control the elements that are displayed as part of the map. As will be described in more detail below, the interactive area guide application 20 uses a database 19 of destination content information and a database 18 of advertising content to overlay information on the map object received from map application 13 to enable a traveler to visualize and customize their view of resources in a particular area.

The web browser 12 is a computer program (for example, Netscape Navigator or Microsoft Internet Explorer) that retrieves web pages from the web servers 16A and 16B via the Internet and delivers the page to the client computer system 10. The application 20 forwards customized web pages to the browser for display on the users' GUI.

One common problem with existing map web pages is that they often include too much or too little information, making it difficult for a user to discern available resources when visiting an area. For example, although travel web sites may provide hotel locations in response to a city search, it is often difficult for a user to locate a hotel that is close to a particular event that they are attending. Often users find themselves lodging at locations that are inconvenient given their travel itinerary.

The interactive area guide application 20 of the present invention enables a user to customize the overlay information displayed on a map web page by selecting for display only those points of interest that are relevant to the user. This information may be used to enable the user to quickly link event, lodging and other information. Various components of the overlay information include icons, an information panel, drop-down lists and pop-up windows, each of which may use color to assist in visual differentiation of the points of interest.

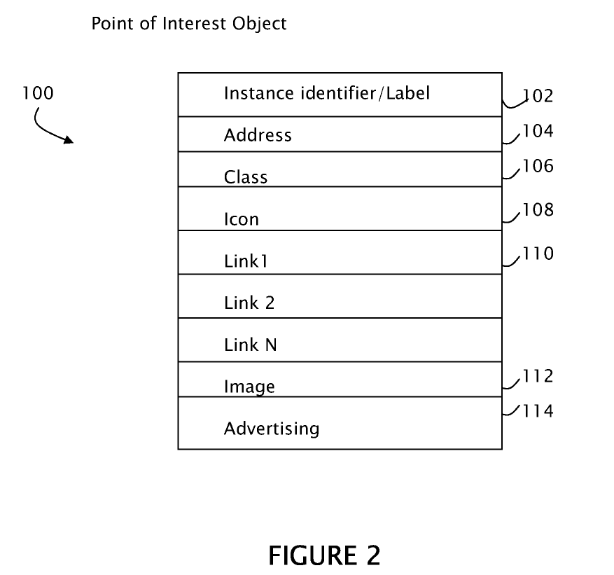

FIG. 2 illustrates various information that may be included as part of a point of interest object 100. This information includes an instance identifier (or label) 102, an address (which may include, for example, street, city, state and phone number, longitude and latitude) 104, a class 106, an icon 108, one or more links 110 related to the point of interest (including, for example, a link to a reservation site for the point of interest, an availability site for the point of interest, a direction web page to find direction for the point of interest, etc.), an image 112 and advertising content 114 (which may include fixed or dynamic information or links to other information). It should be recognized that FIG. 2 illustrates only one example of an embodiment of a point of interest object; it is recognized that there may be many different fields that may be added or deleted from the object, and many different arrangements of fields within the object that may be used to implement the concepts of the present invention. Thus the present invention is not to be limited to the inclusion of any particular fields in a point of interest object, but rather any object that provides information that may be considered relevant by a particular traveler or type of user of the map is considered an equivalent of the object 100 and within the scope of this invention.

It is also recognized that there are a variety of different types of points of interest, and the points of interest used in particular embodiments of the present invention may vary depending upon the particular user of the map and their desired use of the map. Thus, although points of interest are described herein as including those used by travelers, the present invention is not limited to the customization of display of any particular type of point of interest, but rather can be expanded to include customization of display of any point that is locatable on a map.

However, by way of example only, a set of points of interest classes that may be provided for use by travelers include but are not limited to Attractions, Aquariums, Auction Houses, Concert Halls, Galleries, Getting Around (Public Transportation sites), Libraries, Hotels, Movie Theaters, Museums, Nightclubs, Services, Shopping, Sightseeing, Sport Arenas, Theaters, Visitor Info and Zoos. Each class may further include a sub-class. For example, the Hotel class may be further apportioned into classes by hotel quality (i.e., 1 star, 4 star, etc.). The Museum class may include the sub-classes Art Museum, Children Museum, Historical Museum, Maritime Museum, Military Museum, Science Museum, Sport Museum, Technology Museum, Wax Museum, etc. The Nighclub class may include the subclasses Blues Club, Comedy Club, Country Club, Folk Club, Jazz Club, Rock Club, etc. Thus it can be seen that the selection of particular points of interest and classes are a matter of design choice.

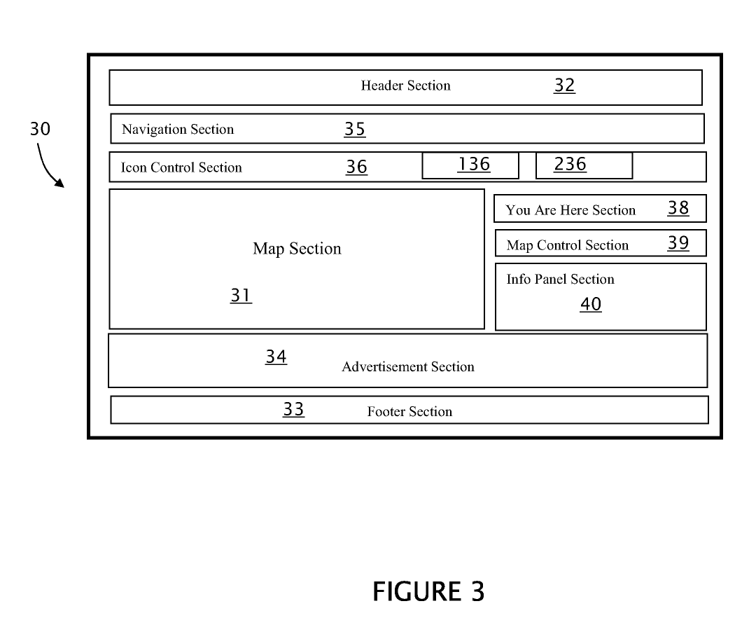

FIG. 3 illustrates an exemplary embodiment of elements that may be included in a web page 30 provided by the interactive area guide 20 of the present invention for display by a browser on a users GUI. The elements include a Header Section 32, a Navigation Section 35, an Icon Control Section 36, a Map Section 31, a You are Here Section 38, a Map Control Section 39, an Info Panel Section 40, an Advertisement Section 34 and a Footer Section 33, each of which will now be described in more detail.

Header, Navigation, Advertisement and Footer Sections

The Header Section 32 is an area at the top of the screen. In one embodiment the header section may be used to display a logo of a host of the interactive area guide web application. For example EventJar of Beacon Street, Boston Mass. is one company which hosts a web site that provides web pages as will be described herein.

A Navigation Section 35 may be provided to display the links that were traversed by a user to get to the web page 30, to facilitate return to previous pages.

The Advertisement Section 34 is an area below the Map Section 31 and Info Panel Section 40, and above the Footer Section 33. Data within the Advertisement Section may include advertisements from an ad server, such as Google AdSense or FastClick, or from EventJAR's in-house ad database, obtained as described in any one of the following patent applications, each filed Jun. 29, 2005 and incorporated herein by reference: patent application Ser. No. 11/169,361 entitled “Method and Apparatus of Advertising Using HTML Ads”, patent application Ser. No. 11/169,422, entitled “Method and Apparatus for Serving Dynamic Web Pages Including Ads”, patent application Ser. No. 11/169,421 entitled “Method and Apparatus for Serving Ads of Different Types to the Same Location in a Web Page”, patent application Ser. No. 169,420, entitled “Method and Apparatus for Selecting Ads to Serve on a Web Page” and patent application Ser. No. 11/169,390 entitled “Advertising Tool for Ad Customization.”

The Footer Section 33 is an area below the Advertisement Section. Data within this area may include standard bottom of page information, such as About Us, Site Map, Terms of Use, Submit Your Site, Contact, Sign In, Privacy Policy, Advertise With Us, and Related links; copyright notice; and company name and address.

Map Section

The Map Section 31 is an area below the Icon Control Section 36 and above an Advertisement Section 34 and contains a Google Map object, provided by Google™ of Sunnyvale Calif. The Google Map object is embedded in the page 30 using Google Maps JavaScript API. The map object may include an overlay on the left-hand side on the map to allow a user to move the map being displayed to the left, right, up, or down. There is also a control to zoom in and zoom out the map. The map object has an API that allows a browser script to add and remove Icons and provide contents for Pop-Up windows.

The Map Section 31 has the following features: If the browser window width is changed, the Map Section will be resized by the interactive guide web application by the same amount. Resizing the Map Section will cause the Google Map object to be resized. If the browser window height is changed, the Map Section will be resized by the same amount. Resizing the Map Section will cause the Google Map object to be resized.

The map section displays a portion of a map of a pre-selected area. In one embodiment, the area has been pre-selected through a parent application, such as an event based application, travel based application or the like. In an alternate embodiment, a user may select an area to map at a user prompt, using a pull-down menu or other form of user input device. It will be appreciated that points of interest are associated with a such a pre-selected area.

Map Control Section

The Map Control Section 39 is an area to the right of the Map Section, below the You Are Here Section, and above the Info Panel Section 40. The Map Control Section 39 in one embodiment includes two buttons to control the format of map to be displayed, for example street map or satellite image. When the Street Map button is clicked, the map in the Map Section 31 is displayed in a street map format. When the Satellite Image button is clicked, the map in the Map Section 31 is displayed in a satellite image format. The hyperlinks in the map control section are coupled to APIs of the Google map to use the Google Map visualization control tools.

Icon Control and Info Panel Section

An Icon Control Section 36 is an area below the Navigation Section, and above a Map Section 31 and a You Are Here Section 38. In one embodiment the Icon Control section 36 comprises two drop-down list objects 136 and 236. The drop-down lists are associated with point of interest objects. As described above with regard to FIG. 2, each point of interest object includes an icon, an instance identifier (or label), a location and a class. A Marriott point of interest, for example, may have a Marriott identifier, a location value corresponding to its address, a label corresponding to its particular name, and a class of ‘hotel’. Other elements of a point of interest object will be described in more detail later herein. Selection of a point of interest from the drop down list generates an Icon object (marker) associated with that point of interest. Each Icon object may include information such as the size, color, label and location (or anchor) of the Icon, as well as a link to a pop-up window associated with the point of interest and an anchor for the pop-up window. In one embodiment, each Icon object and pop-up window object for a point of interest is populated upon selection of the point of interest or point of interest class.

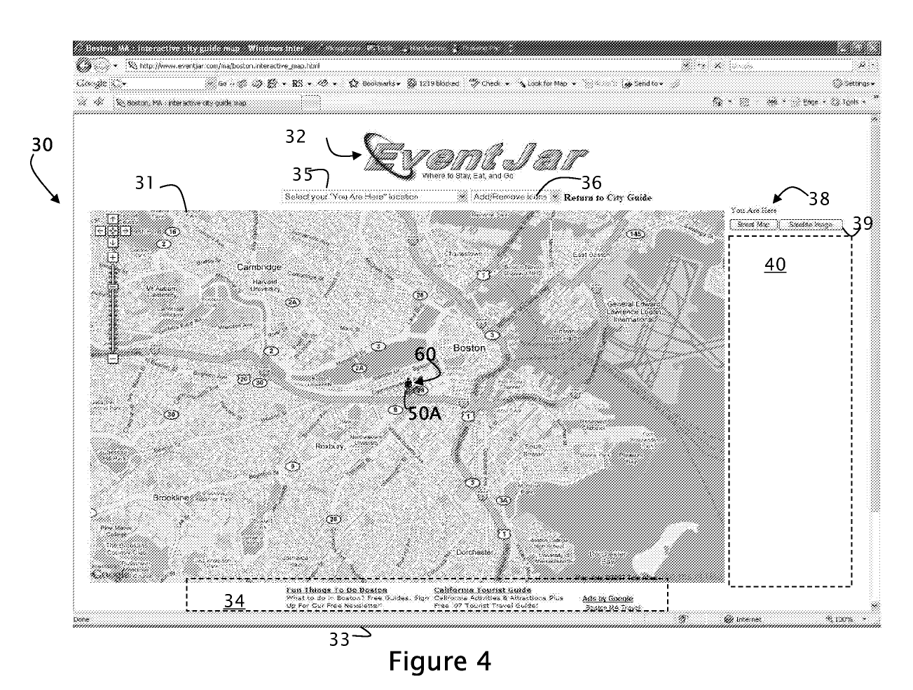

A first drop down list 136 comprises a list of pre-determined point of interest instance identifiers (or labels) that may be associated with a “You Are Here” object. In one embodiment the “You are Here” object is shaped as a so-called Little man Icon. An example of a Little man Icon 60 at a point of interest 50A is shown in FIG. 4. The Little Man Icon thus provides a visual indication to the location of the user on the Map Section 31.

The selection of one of the pre-determined points from the first drop down list populates the You are Here object with the selected point of interest and places the Little Man icon on the map at the selected point of interest. For this reason, the first drop down list is also referred to herein as the Point of Interest list. The point of interest list 135 may be used together with the Little Man icon 60 by a user to place him or her self at a particular location on the map, enabling the user to visualize their location relative to other classes of points of interest.

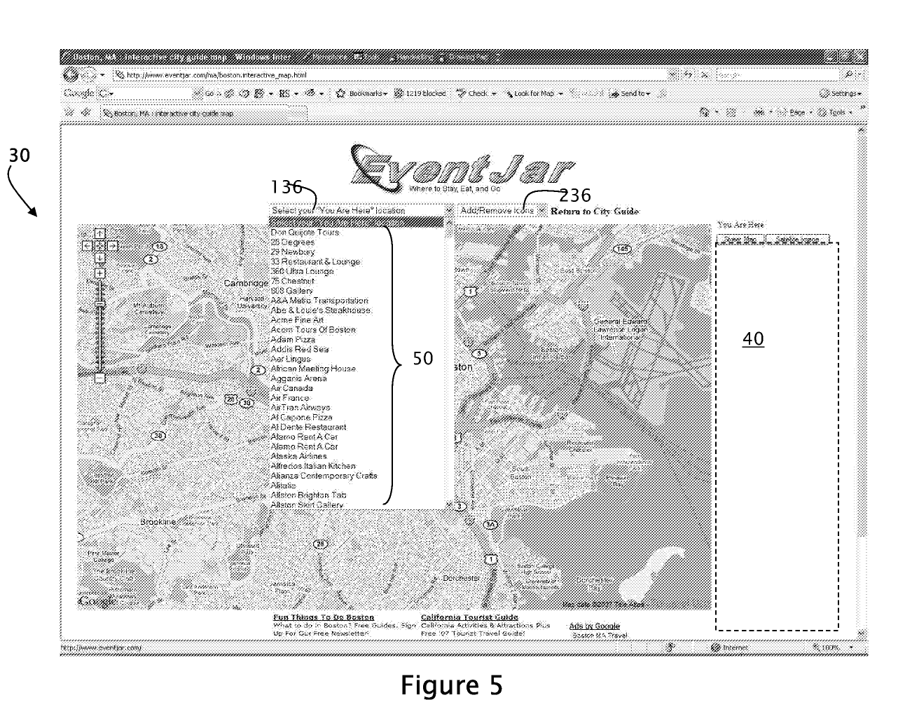

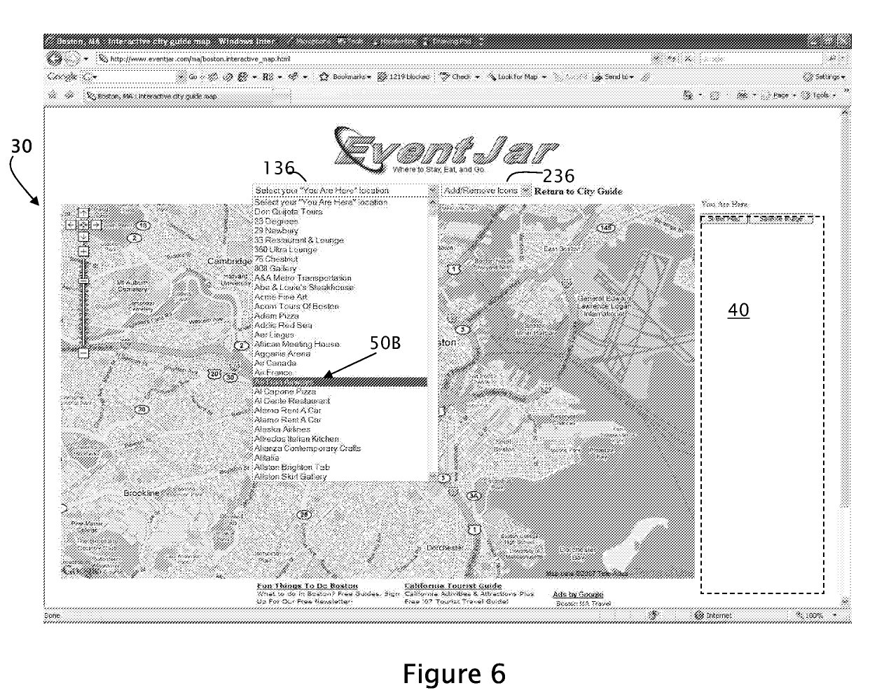

Referring now to FIG. 6 the Point Of Interest (POI) list 136 is shown in more detail to include a list 50 of labels associated with known point of interest instances. For example, the list could be populated with the instance identifier 102 of the object 100 (FIG. 2). Each POI instance is stored in a database at a web server. In one embodiment, the POI instance information is manually populated. In alternate embodiments, the point of interest instance can be discovered using techniques such as those described in patent application Ser. No. 11/171,003, entitled “Event Entry tools” filed Jun. 29, 2005 and incorporated herein by reference. FIG. 6 illustrates the selection of a POI 50B from list 50 and FIG. 7 illustrates how the Little Man Icon 60 is moved to the selected POI 50B. As can be seen by comparing FIGS. 5 and 7, view in the portion of the map displayed in Map Section 31 is advantageously shifted such that the Little Man Icon is centered in the Map Section 31 whenever the POI of the Little man is modified.

It is envisioned that manual methods of placing the Little Man on the map may also be provided, for example, by allowing a user drag the Little Man across the map using a mouse click. In such an embodiment, population of the You are Here object may happen after the Little Man is released, by mapping the Little Man object to the most proximate known POI.

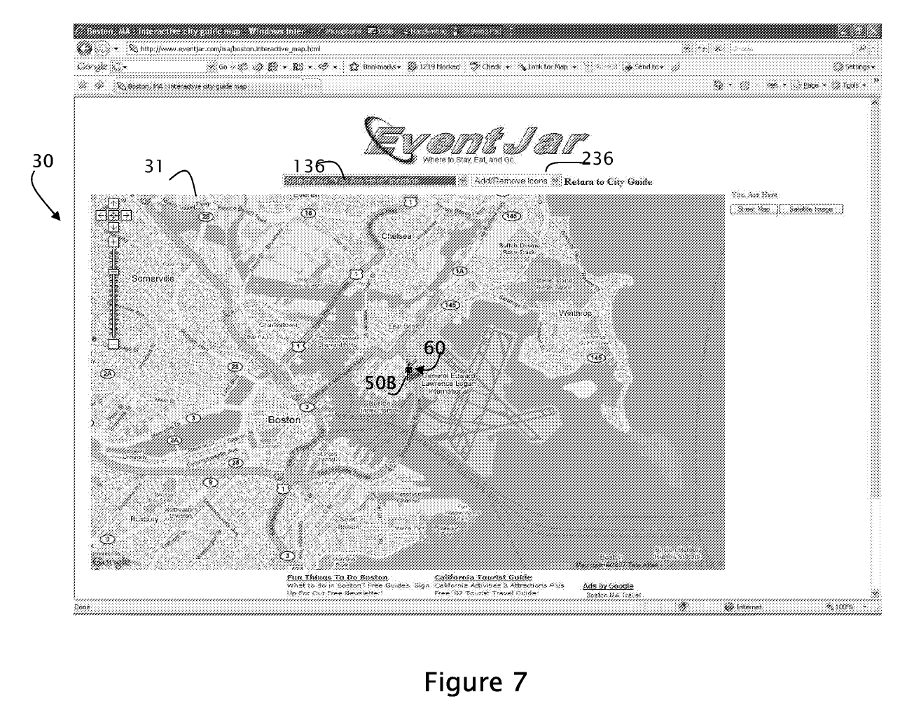

Referring now to FIG. 8, a flow diagram is provided to describe the process used to populate an Icon object and deliver the Icon object to the map application for display on the user GUI. At step 150 the Point of Interest List is displayed to the user. The Point of Interest List is an object which is populated with labels or instance identifiers of known point of interests stored in the database 18 for each area. The Point of Interest List object is forwarded to the browser application to be displayed as a drop down list.

At step 152 the icon display process waits for selection of one of the items from the list. At step 154 once a point of interest is identified, a Little Man Icon 155 is populated with information such as the icon label, size, shape, anchor, color, etc. At step 156 the icon is then passed to the map application which populates the map section 31 of the window with the Icon. The Icon Object may also be stored in a list (not shown) of objects currently displayed on the map. At step 158 the map is displayed on the user's GUI and at step 159 the map is centered at the location of the Icon Object.

It should be noted that in an embodiment when the point of interest identifies a user's particular location, it may be desirable to limit the display of this particular icon to one per map. In such an embodiment, the process also forwards a remove icon message to the Map API, using the Icon label of the previously generated ‘You are Here’ object. In an alternate embodiment, the icon may be assigned a class ‘You are Here’, and the Icon display process may first remove all ‘You are Here’ Icons before adding the new Icon 155. It is recognized that there are various processes that could be applied to achieve similar results, and all are within the scope of the present invention.

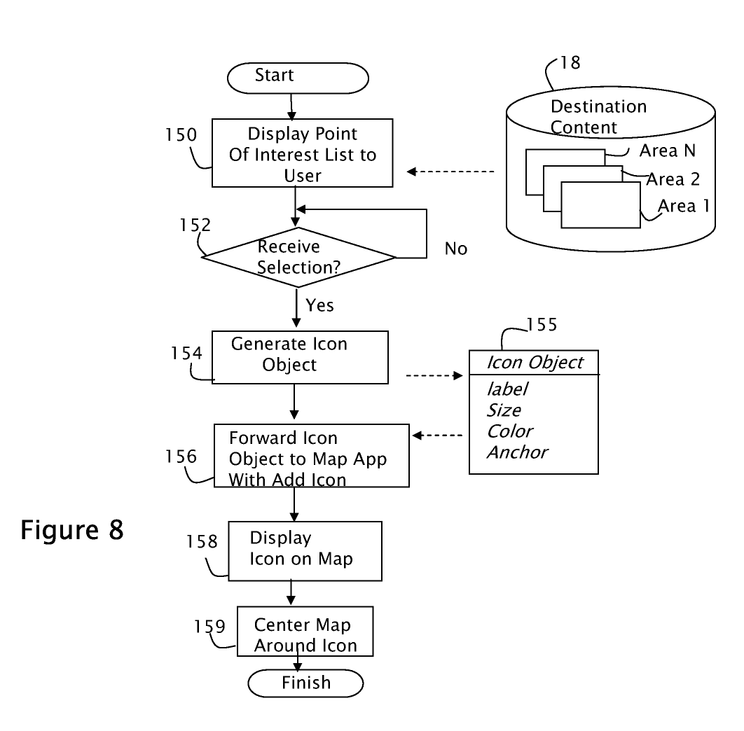

Referring back to FIG. 3, the “You are Here Section” 38 of the page 30 includes a link which, when selected, invokes a routine that delivers a pop-up window to the map application providing POI information associated with the location of the Little Man. An example of an intelligent pop-up window 130 that would be provided with the Little Man at POI 50B is shown in FIG. 9. A more detailed description of the intelligent pop-up window will be provided later herein.

Referring back to FIG. 3, a second drop down list 236 groups POI by class and facilitates location of classes of points of interest on map 31. The second drop down list is associated, in one embodiment, with icons, and for this reason is also referred to as an Add/Remove Icon object. Different icons may be provided for different classes of POI to provide additional visual cues to the user regarding the located POI. The Add/Remove Icon object permits a user to add or remove icons from the map, depending upon the particular needs of the user.

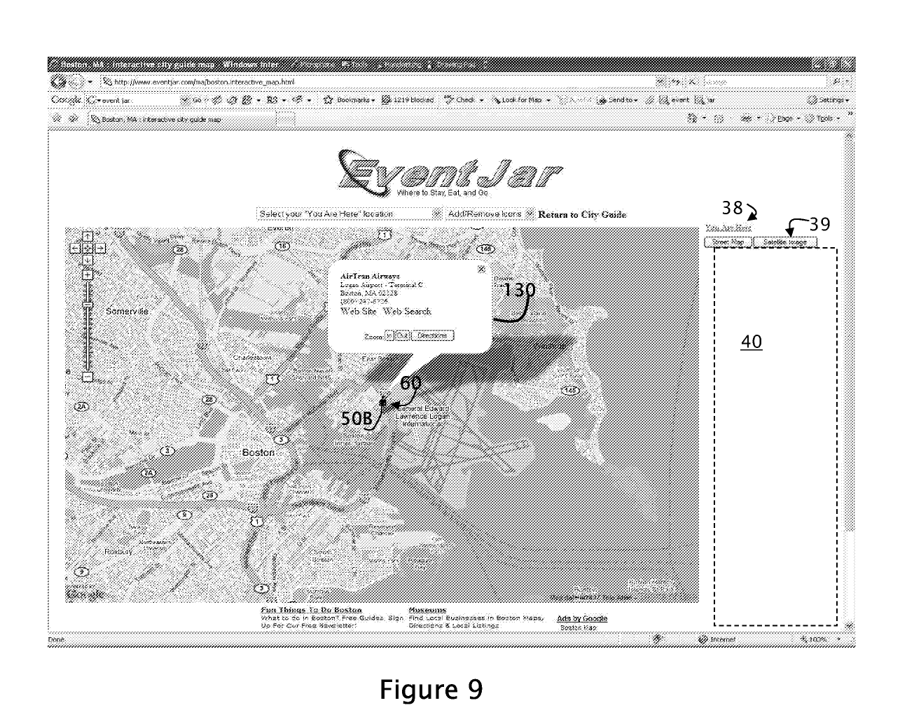

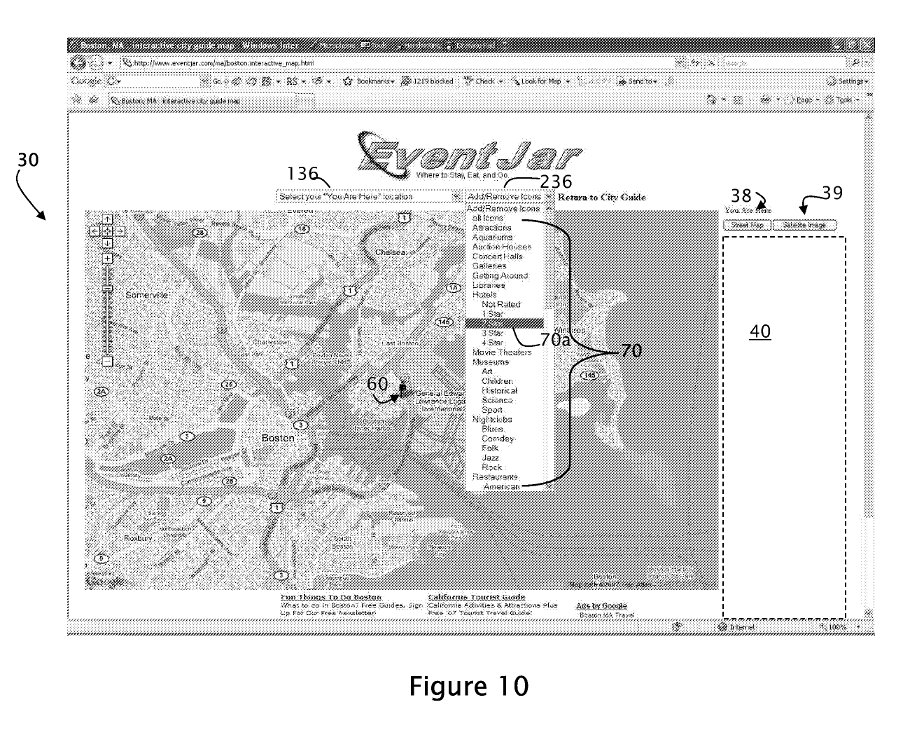

FIG. 10 illustrates one embodiment of an Add/Remove drop down list 70 which includes a plurality of selectable POI classes. In FIG. 10, the class 70a corresponding to ‘2 Star Hotel’ is selected. As shown in FIG. 11, in response to this selection a plurality of Icons 70-a-1->70a-N are displayed at POI in the map section having the 2 star hotel class. In addition, the labels associated with the icons are displayed in the Info Panel Section 40.

The Info Panel Section 40 is an area to right of the Map Section 31, below the Map Control Section 39 and above the Advertisement Section 33. The Info Panel Section comprises a list of hyperlinks with names of the specific class instances used as anchor text. Hyperlinks are added and removed form the list by the “Add/Remove Icon” object of the Icon Control Section.

According to one aspect of the invention, a different color and text code is associated with each POI class and subclass. The color and text code are used to customize the icon for the particular class/subclass. In addition, the color is also used to highlight the particular hyperlink associated with the Icon in the Info Panel Section to enable a user to more easily associate the hyperlinks of the Info Panel to the Icons.

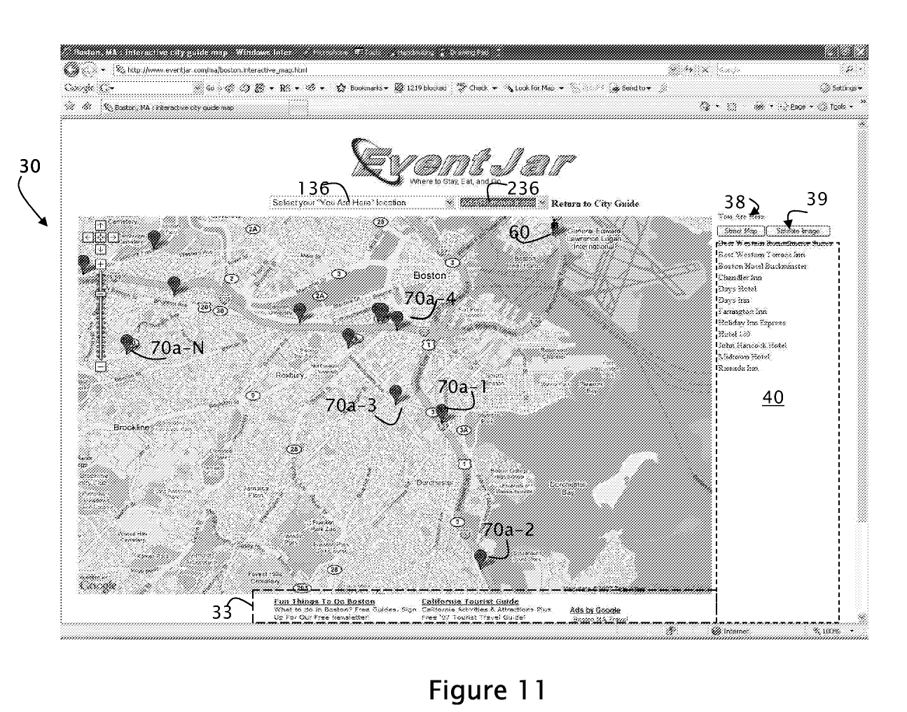

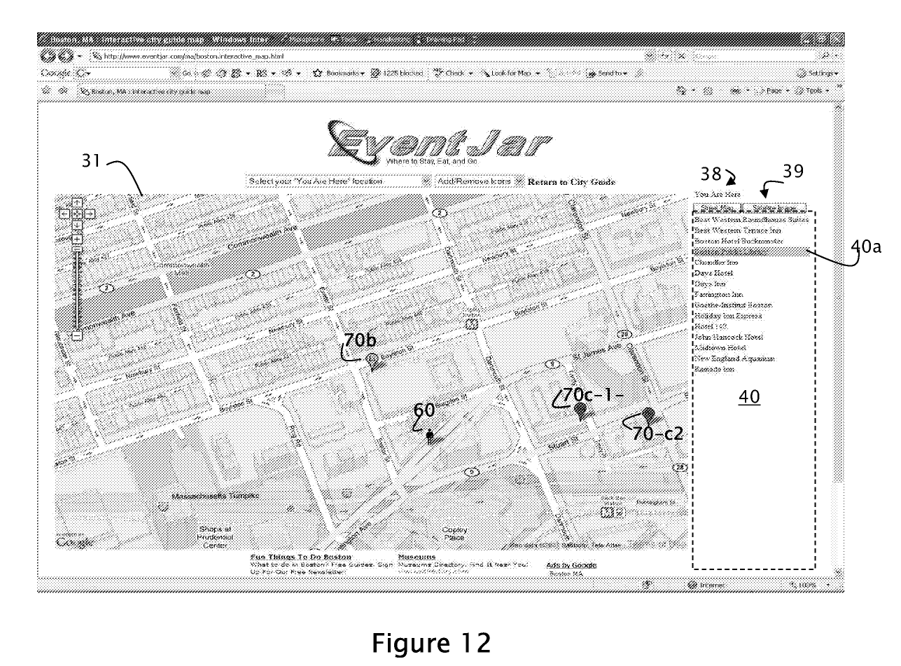

For example, referring now to FIG. 12, a library class of POI Icons 70b and a 2 star hotel class of POI Icons 70c are shown. The library POI 70b is in this embodiment shaded a light color, such as purple, while each of the 2 star hotel class of POI's (70c-1 and 70c-2) are shaded a darker shade, such as red. When the user hovers a mouse over the Info Panel 40, an entry 40a associated with the library POI is highlighted in the same color as the Icon 70b. In FIG. 13, when the mouse is moved over a hyperlink associated with a 2 star hotel class object, the hyperlink is highlighted with the darker color associated with Icons 70c. With such an arrangement a user can easily correlate the labels to the POI when multiple classes of POI are displayed on the map and within the Info Panel 40.

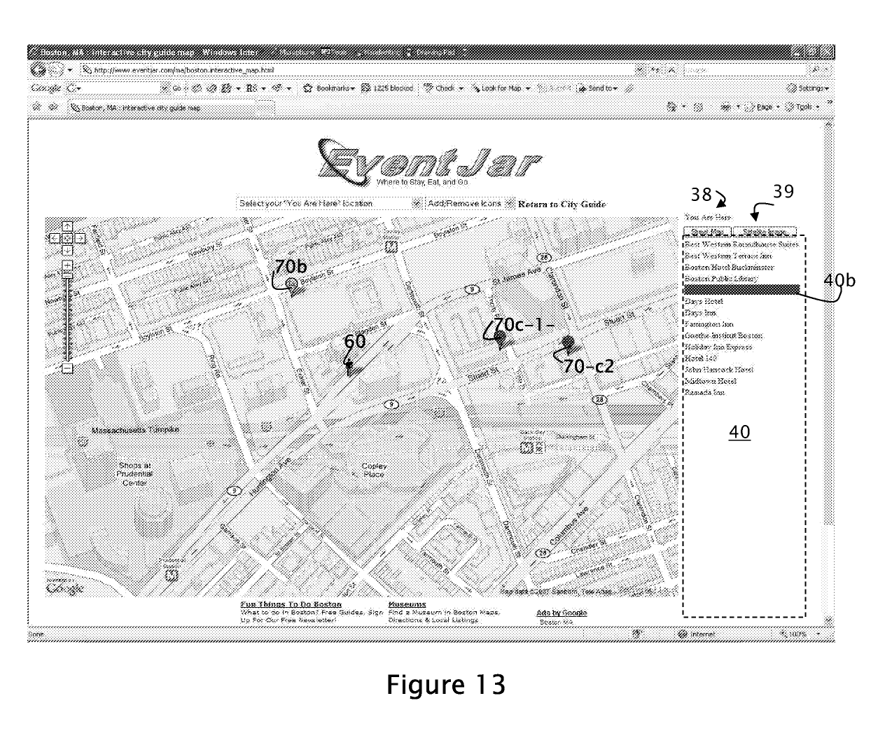

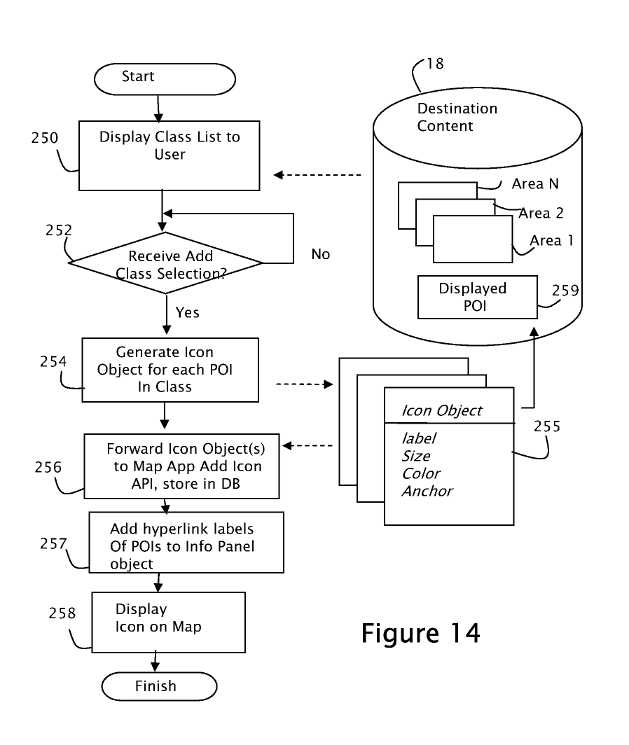

Referring now to FIG. 14, a flow diagram of exemplary steps that may be provided to populate the map section 31 and info panel 40 with Icons and associated hypertext links will now be described. At step 250 the Add/Remove Class List 236 is displayed to the user. The Class List is an object which is populated classes and sub-classes of known point of interests stored in the database 18 for each area. The Class List object is forwarded to the browser application to be displayed as a drop down list.

At step 252 the icon display process waits for selection of one of the classes from the list. At step 254 once a class is identified, a plurality of points of interest Icons 255 are populated (one per each POI in the class in the portion of the displayed area). The Icons are populated with information such as the icon label, size, shape, anchor, color, etc. At step 256 the icons are then passed to the map application using an Add Icon API, which populates the map section 31 of the window with the Icons. The Icon Objects may also be stored in a list 259 of displayed POI. At step 257 hypertext labels associated with each of the objects 255 are displayed in the Info Panel 40. As mentioned above, the hypertext labels may also have a highlight color information stored therewith. At step 258 the map is displayed on the user's GUI. The Class List 236 is augmented with a sign next to the selected class to indicate that the class is displayed on the map.

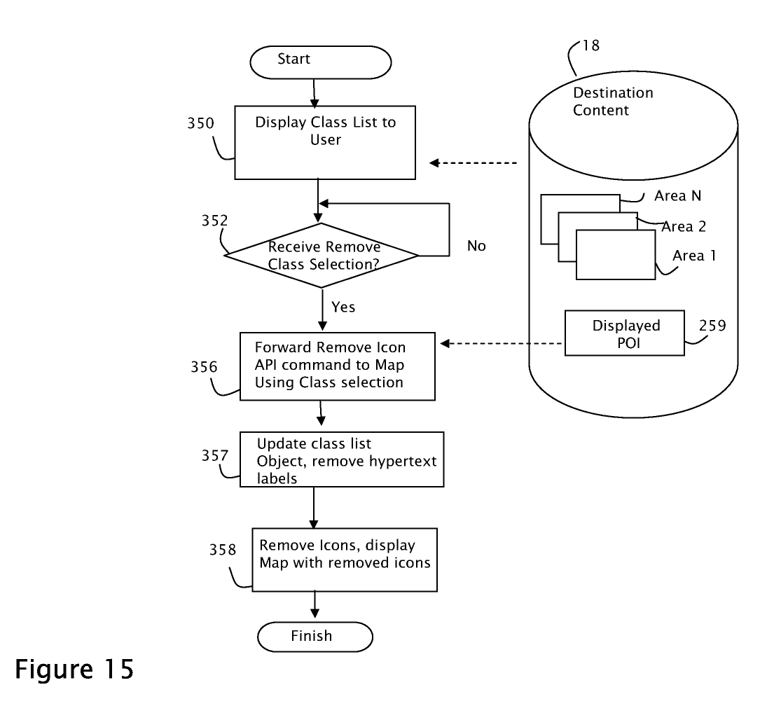

FIG. 15 illustrates a process that may be followed to remove the class Icons from the map. At step 350 the class list object is displayed to the user and at step 352 a de-selection of a class is received. At step 356 the process retrieves all POI instance labels from the database 259 and forwards a Remove Icon command via the map API to the map application for each icon associated with the de-selected class. At step 357 the process updates the class list object to remove the ‘+’ from the associated class and removes the hypertext labels of POIs from the information panel object and at step 358 the map application removes the de-selected Icons and displays the map to the user.

As described with regard to FIG. 8, it is recognized that there are various processes that could be applied to achieve similar results for identifying classes, identifying points of interest associated with classes, generating objects associated with selected POIs and forwarding the object information to a map program, as well as instructing a map program to remove Icons. All processes that achieve the same result are within the scope of the present invention.

Pop Up Windows

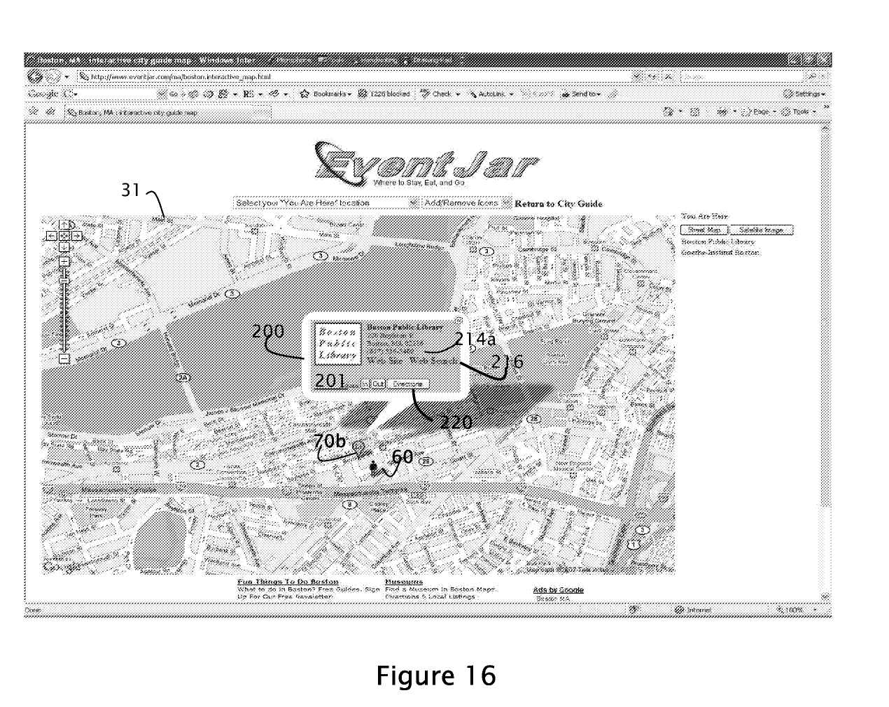

According to another aspect of the invention, an intelligent pop-up window object is also associated with each POI. The intelligent pop-up window is stored as an object that is linked both to an Icon object and to a hypertext link in the Information Panel. In one embodiment, the background color of the pop-up window is selected to match the color of the Icon, although this is not a requirement of the invention. FIG. 16 illustrates an exemplary pop-up window 200 that may be included with the library icon 70b. Pop-Up Window 200 is shown having a background 201 shaded with the same color as Icon 70b. As mentioned above, a Pop-Up Window may appear either when a map Icon is clicked, or when a specific POI class instance name in the Info Panel Section is clicked.

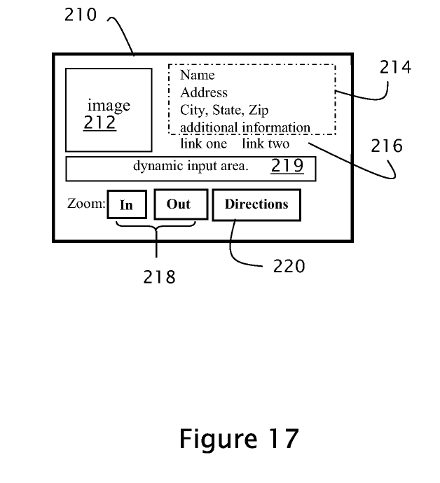

Pop-Up Windows are used to temporary display information about a POI instance. The POI instance with which pop-up windows may be associated include both ‘You are Here’ POI instances as well as Class Icon instances. An exemplary layout of a Pop-Up Window 210 is shown in FIG. 17. The pop up window of the present invention comprises a combination of text, images, hyperlinks, buttons and dynamic input fields which together provide a robust, centralized information repository for the POI. The pop-up window may include an image 212, zoom control 218, a direction button 220, location information 214, and one or more links 216. The present invention is an intelligent pop-up window where the various elements of the pop up window are populated differently depending upon the class of the POI.

The image 212 may be any available image that is related to the specific class instance. The image could be a small image advertisement, logo, branding information, or information image. For example, a map icon showing the location of a hotel, could display an image of the specific hotel or an advertisement for a hotel special offer. The image may be a fixed image, stored as part of the pop-up window object or may be a dynamic image which is received from the POI, and updated freely by the POI. The location field 214 may be populated with the name and address of the specific POI instance. Additional information regarding the POI may be provided in the location field 214. The additional information may include text, hyperlinks, images, or any other type of information that may be relevant to the POI instance. As mentioned above, the additional information may vary depending upon the class of the POI.

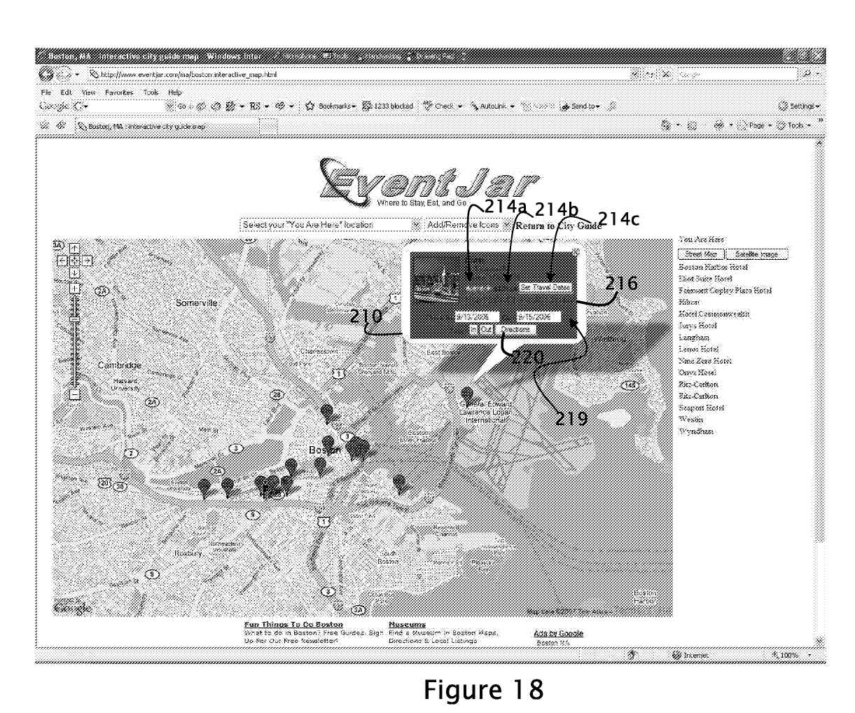

For example, referring back briefly to FIG. 16, for non-hotel class POI, the additional information 214a may include class instances' phone number, if one is available. Alternatively, as shown in FIG. 18, for hotel class POI, the additional information may include a hotel rating 214a (if available), a room rate (if available) 214b, and a Set Travel Dates button 214c.

According to one aspect of the invention, the contents of the dynamic input area 219 may be modified through selection of links in the intelligent pop-up window 210, in response to the particular class of POI instance associated with the pop-up window. For example, when a Set Travel Dates button 214c is clicked, 2 text input fields prompting travel date entry will appear in the dynamic input area 219. This will prompt the user to enter a check-in and check-out date. In one embodiment, if this is the first time the user is asked for dates the fields could be set to the current date plus one and current date plus two, else the field could be initialized with the dates the user last entered.

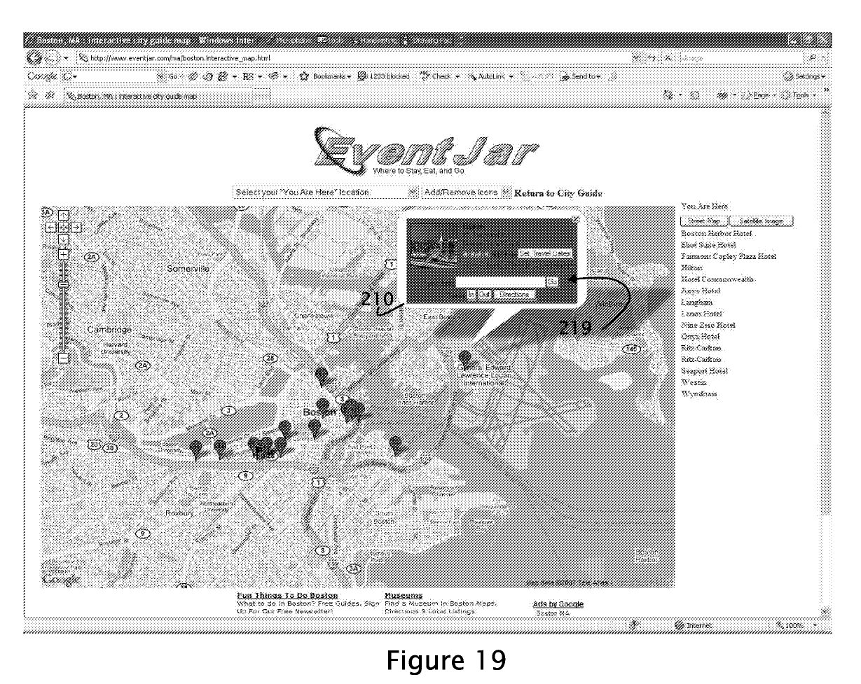

The dynamic input window may also be populated by the selection of other links in the intelligent pop up window, including the selection of the directions button 220. For example, referring now to FIG. 19, in one embodiment, the selection of the directions button causes a pop-up entry prompting starting address to be displayed in the dynamic input window. The starting address will be forwarded to a third party application with the POI address, to provide directions to the POI to the user. Thus it can be seen that the dynamic input window can be used to prompt the user for information that may be fed other applications which may be used to assist the user in their travel arrangements. The contents of the dynamic input window changes in response to particular selections that are made in the intelligent pop-up window by the user. The dynamic nature of the intelligent pop-up window thus differentiates it from standard pop-up windows which typically are limited to providing pre-defined text or links, thereby improving and simplifying the overall user experience.

The intelligent pop-up window is also ‘intelligent’ because the links that are displayed in link field 216 are intelligently selected based on POI class. For example, as described above with regard to FIG. 16, for non-hotel class instances, link one may provide a Web Site link for that class instance, if one is available, and link two may provide a Web Search link for that class instance. As described with regard to FIG. 18, for hotel class instances link one may provide a Hotel Information link for that class instance and link two may provide a Hotel Booking link for that class instance.

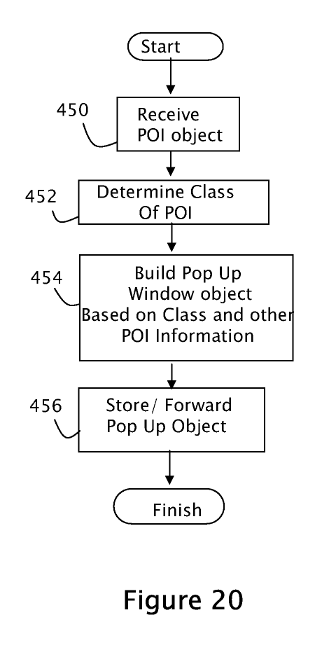

Referring now to FIG. 20, a flow diagram illustrates exemplary steps that may be performed to build a pop-up window object of the present invention. At step 450, when a POI is identified, the POI object is forwarded to the pop-up window build process. The pop-up window may be built dynamically (either through selection of the POI via the Icon or via the hypertext label in the Info). Alternatively the POI pop-up window object may be built when the POI identified via selection of a POI in the POI list or via selection of a class of POI's in the class list. POI pop up windows that are generated when POIs are selected from the list objects may be stored in a database (not shown) for use when one of the POI icon or POI hypertext link is selected.

At step 452 the class of the POI is extracted from the POI object. At step 454, the class information is used to populate the POI pop up window. For example, the class will be used to determine the color of the background of the pop up window, the additional information to provide in field 214 and links to provide in link field 216. POI information may used to identify an image or advertising to provide in field 212 as well as location information to provide in field 214. At step 456 the POI pop-up window object is either stored in a database or forwarded to the map API for display.

Accordingly an intelligent pop-up window has been shown and described which is dynamically customized in response to POI class though population of links and display of background color. The pop-up window is also customized in response to the particular POI, for example through display of associated images and advertising. A dynamic input field is selectively populated during use of the pop-up window in response to user link selection. The intelligent pop up window is flexibly invoked, by Icon or Information Panel selection, to facilitate access to the POI and its associated information. According to another aspect of the invention, the pop up window may be invoked in response to the user's mouse hovering over the point of interest icon or hypertext label for a predetermined time.

Paging Buttons

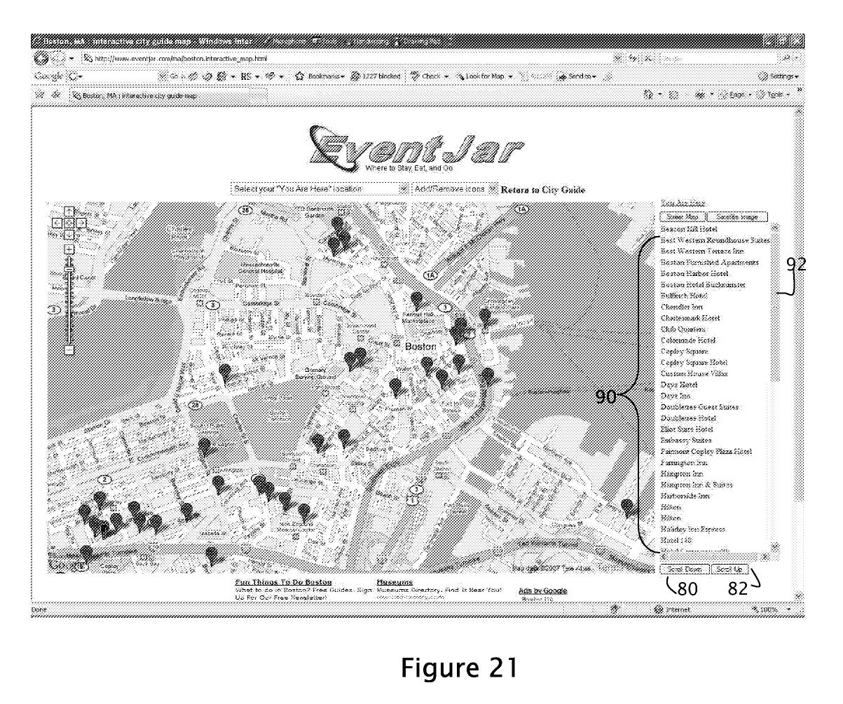

Returning to the discussion of the Information Panel 40 and referring now to FIG. 21, if the number of hyperlinks in the Information Panel 40 becomes too large to all be displayed Info Panel window, a vertical scroll bar 92 will appear along the right-hand side of the Info Panel Section.

Vertical scroll bars are commonly used in browser windows when the amount of text or elements are too large for the displayed window. One problem with vertical scroll bars is that they are often difficult to manipulate; they require the user to do a drag and drop of a small button on the side of the screen and a user may have difficulty tracking their movement of the button to the text through the window. As a result, users often overshoot or undershoot the scroll, losing visibility of the desired element on the web page.

According to one aspect of the invention, the generation of the vertical scroll bar also results in the generation of two paging buttons 80 and 82. The Scroll Up and Scroll Down paging buttons 80 and 82 enable a user to quickly page up and down the set of labels in the info panel 90 without having to use the scroll bar. The buttons interface with the scroll bar APIs such that each click of one of the buttons 80 or 82 moves the scroll bar through a page.

When the Scroll Down button is clicked, the vertical scroll bar and hyperlink list will be scrolled down by the number of visible hyperlinks, or to the bottom of the list if number of non-visible hyperlinks on the list is less than the number of visible hyperlinks. When the Scroll Up button is clicked, the vertical scroll bar and hyperlink list will be scrolled up by the number of visible hyperlinks, or to the top of the list if number of non-visible hyperlinks on the list is less than the number of visible hyperlinks.

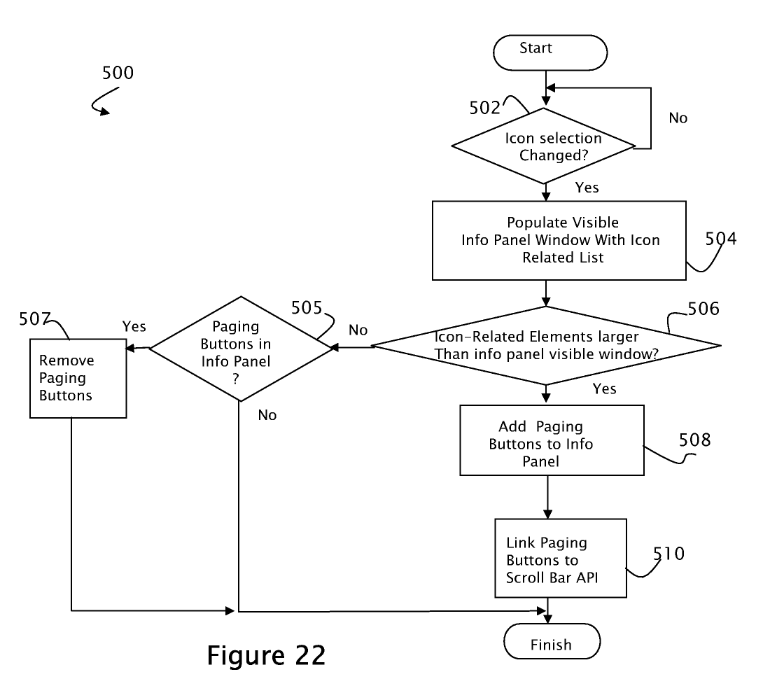

In one embodiment, the buttons of the present invention are linked to the scroll bar API of the browser. An exemplary process is shown in FIG. 22 that controls the appearance or disappearance of the buttons on the web page 30.

When at step 502 it is detected that the class icon selection has been changed (via selection or de-selection of elements from the Add/Remove Icon Class list 236), then at step 504 the Information Panel is populated with the hyperlink labels of each of the currently visible classes on the map. At step 506 the browser determines if the number of hypertext labels exceeds the visible area in the Information panel. If so, at step 508 a scroll bar is added. The present invention uses this interrupt to also place the scroll buttons 80 and 82 at the bottom of the Info panel. At step 510 the buttons are linked to the scroll bar to facilitate paging through the list of hypertext labels.

If at steps 506 and 505 it is determined that a de-selection of a class has caused the number of hypertext labels in the window to be reduced so that they fit into the window, and the scroll buttons had been present, then at step 507 the paging buttons are removed from the information panel. With such an arrangement, the ease of use of the web page 30 is increased by removing the need to use a scroll bar. Although the scroll buttons have been described in the context of the web page of the present invention, it should be recognized that the concept of the present invention may be extended for use in any browser window that includes a vertical scroll bar.

Accordingly a method of populating an interactive map to enable users to more easily find attractions and interests of their choice in an unknown area has been shown and described. The method allows users to pick and choose multiple classes of points of interest to as an information overlay on local city maps, such as hotels, galleries, museums, theaters, shopping malls, etc. The information overlay includes icons, pop-up windows and information panels which provide information regarding the points of interest. Pull down menus permit the user to customize their map to display one or more points of interest by location or class. Visual cues, including color coding, icon shaping and text differentiation for different classes of points of interest allow a user of the map to quickly differentiate area resources. With such an arrangement a traveler can easily select for display only those particular resources that are of interest to the traveler and thereby create a local search experience focused on their specific travel needs.

In one embodiment the interactive area guide methods and system are embodied as HTML and JAVAscript code which is stored on a computer readable medium and used to populate web pages that are served to the user. It is appreciated that the present invention may be embodied in many forms, and thus should not be limited to the particular embodiment provided herewith.

The disclosed system can take the form of an entirely software embodiment, an entirely hardware embodiment, or an embodiment containing both software and hardware elements. The figures include block diagram and flowchart illustrations of methods, apparatus(s) and computer program products according to an embodiment of the invention. It will be understood that each block in such figures, and combinations of these blocks, can be implemented by computer program instructions. These computer program instructions may be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using wireless, baseband signaling or broadband signaling techniques, including carrier wave signaling techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed.

1. A method for enabling paged scrolling through a list of elements displayed on a web page, the web page stored on a computer readable medium and displayed to a user using a browser, the method including the steps of:
monitoring a browser window to determine when the number of elements in the browser window is outside the viewable space and a vertical scroll bar is added to the browser window; and
in response to the vertical scroll bar being added to the browser window, displaying a scroll button in the browser window, the scroll button enabling paging of the viewable contents of the browser window without use of the scroll bar.

2. The method of claim 1 including the step of monitoring the web browser to determine when the number of elements in the browser window is less than the viewable space; and
in response to the scroll button being displayed in the browser window, and in response to a determination that the number of elements in the browser window is greater than the viewable space, removing the scroll button from the browser window.
